(19) United States
(12) Patent Application Publication
(10) Pub. No.: US 2011/0316355 A1
(43) Pub. Date: Dec. 29, 2011

(54) Shockproof Electric Outlets

(76) Inventors: Dennis W. Gruber, Arlington Heights, IL (US); Daniel J. Masterson, Geneva, IL (US); Daniel M. Namie, Elburn, IL (US)

(21) Appl. No.: 12/522,000

(22) PCT Filed: Dec. 28, 2007
(86) PCT No.: PCT/US07/26455

§ 371 Date: Jul. 2, 2009

Related U.S. Application Data
(60) Provisional application No. 60/878,101, filed on Jan. 3, 2007.
(60) Provisional application No. 60/878,102, filed on Jan. 3, 2007.

(51) Int. Cl. H02H 7/22

(52) U.S. Cl. 307/326

(57) ABSTRACT

An apparatus in an example comprises a proximity sensor and a controller. The proximity sensor serves to indicate a presence of a living object within a preselected distance of an electrically powered outlet receptacle. The controller performs a preselected control action in connection with an operation of the electrically powered outlet receptacle upon a determination the living object is within the preselected distance of the electrically powered outlet receptacle.

### BACKGROUND

Electric outlets can cause shocks. The US Consumer Product Safety Commission's “CPSC Document #524” on “Electrical Receptacle Outlets” (World Wide Web CPSC dot GOV/CPSCPUB/PUBS/524 dot HTML) estimates that electrical outlets are the cause of 3,900 injuries that require treatment in a hospital emergency room each year, with one third of those occurring when young children insert metal objects, such as hair pins and keys, into the outlets, resulting in electric shock or burn injuries to the hand or finger. Regarding protecting young children, the CPSC says that “parents should consider some precautions: Insert plastic safety caps into unused outlets within reach of young children Be sure that plugs are inserted completely into receptacles so that no part of the prongs are exposed.”

### DESCRIPTION OF THE DRAWINGS

Features of exemplary implementations of the invention will become apparent from the description, the claims, and the accompanying drawings in which:

FIGS. 1 and 2 are block diagrams of implementations of an apparatus.

FIG. 3 is a rear view mechanical layout of an apparatus as in FIG. 1.

FIG. 4 is a front view of an apparatus as in FIG. 1.

FIG. 5 is a perspective view of an apparatus as in FIG. 1.

FIG. 6 is a side view of an apparatus as in FIG. 1.

FIG. 7 is a side view cross section of an outlet cover and/or wall plate of an apparatus as in FIG. 6.

FIG. 8 is an enlarged view of a section of FIG. 7.

FIGS. 9 and 10 represent an exemplary logic flow for an implementation of the apparatus of FIG. 1.

### DETAILED DESCRIPTION

Referring to the BACKGROUND section above, each receptacle terminal that contains a hot (or powered) connection poses a shock or more serious exposure hazard, to children and animals. Typical designs to abate or diminish this hazard rely on making the source of the power unavailable or effectively unusable. Typical designs employ geometric restrictions that involve sophisticated motor skills to gain access to the power source.

Typical plastic inserts, once inserted, can be difficult to remove. Typical plastic plugs render the outlet unavailable and/or inconvenient to use, and then provide no protection when the typical plastic plug is removed to allow use of the outlet. The typical plastic plug also needs manual reinsertion into the outlet to provide its protection. Another design involves simultaneous rotation and insertion of matching male components into a female receptacle. Such designs can be difficult to use and fail to protect against a physically developed child or toddler who has yet to develop the cognitive understanding of the latent dangers around a household receptacle.

It would be desirable to protect against the dangers associated with electrical connections already made, such as plugs already plugged into the receptacle. A shock hazard may exist whenever the plug is partially unplugged, such as by jostling of the cord, while unplugging, or upon discovery by an interested or curious child or toddler.

No protection is typically provided if someone pulls on the cord or trips on it thus pulling the plug partially out of the outlet and exposing live electrical conductors and a serious shock danger. Also, little or no protection is typically provided if the outlet is damaged, possibly even with the use of the plastic plugs.

Exemplary electrical receptacles comprise standard household outlets, outlet replication adaptors, power strips, surge suppressors, extension cords, and other traditional power connectors. The outlets could be placed: inside a wall in a standard electric box; in an outlet replicator, which plugs into and mounts on top of a standard electric outlet in the wall to provide shock-protected outlet(s); in an outlet strip, which will provide shock protected outlet(s); at the end of an extension cord; in a surge suppressed outlet to provide outlets with both surge and shock protection.

Electrical receptacles that pose a shock hazard are omnipresent in homes, garages, workplaces, and the like. The electrical receptacles are employed to provide power for myriad electronic and mechanical devices such as appliances, electronics, lighting, toys, and the like.

An exemplary employment of mechanical changes to the outlet serves to prevent power from being delivered to a load, for example, unless the plug is correctly and fully inserted in the outlet. An exemplary electrical approach serves to sense a moving capacitance within the design distance of the outlet and then turn off the power to the outlet. An exemplary implementation serves to protect from electric shock while still allowing uninhibited access to household power. The protection may be provided to humans and animals. For example, toddlers and infants may be protected.

An exemplary implementation comprises an electrical outlet receptacle, a proximity sensor, a controller, and software. The proximity sensor is located adjacent to or sufficiently near the receptacle opening, for example, near the “hot” lead, to indicate the presence of a person or animal. The sensor sends out a consistent frequency such as a radio frequency, which is attenuated by the capacitance of the nearby person or animal. The controller is operable to perform a predetermined operation responsive to the indication that a person or animal is nearby. Examples of the predetermined operation comprise cutting the power at the nearest receptacle and/or sounding an alarm. The software such as an embedded logic program in an example serves to facilitate a proper, appropriate, and/or desired response, for example, that can accommodate the often changing surroundings. The electrical outlet receptacle, proximity sensor, controller, and software in an example cooperate to provide continuously accessible power while simultaneously reducing and/or eliminating the risk of accidental shock.

Upon connection with electrical power, an exemplary implementation automatically adjusts itself to the static environment where it is located. The adjustment in an example occurs without active contemporaneous user input. If another electric field generating item or an object with sufficiently high capacitance to ground, for example, greater than five picofarads (“pF”), such as a power block for a cell phone or other electronic device, is placed in the immediate vicinity of the outlet, an exemplary implementation senses that capacitance, turns off the power to the electrical outlet receptacle, and recalibrates itself. After the recalibration, an exemplary implementation restores the power to the electrical outlet receptacle. If the capacitance is moving such as by presence of a person or an animal and an exemplary implementation makes a determination the change in capacitance is outside the acceptable change allowed, then the exemplary implementation turns off the power to the electrical outlet receptacle(s), for example, to prevent the possibility of a shock or electrocution.

An exemplary implementation senses a change in capacitance and then employs a triode for alternative current (“triac”), a relay, or other switching mechanism to turn electricity on and off. An exemplary implementation strategically sizes and locates electrodes. An exemplary implementation employs software to filter and/or accommodate noise. An exemplary implementation employs software to provide adaptive logic to accommodate static changes in the environmental capacitance. An exemplary implementation accommodates permanent changes in the baseline or environmental capacitance and permanent or sustained signal disruption caused by electrical or electro-magnetic interference. An exemplary implementation fits in a standard outlet box. An exemplary implementation accommodates flexibility in electrode designs. An exemplary implementation balances noise rejection and sensing resolution and/or sensitivity. An exemplary implementation operates in the presence of vast changes of large magnitude. An exemplary implementation detects slow and/or permanent changes in signal levels.

An exemplary implementation comprises an optional power conditioner and/or voltage regulator; an electric field (“e-field”) sensor and/or controller such as a microprocessor; and software. The electric field sensor in an example serves to sense a change in capacitance caused by a moving living object. The software in an example serves to automatically and/or without active contemporaneous user input, adjust for the presence of static capacitance, for example, electric field producing items in the immediate vicinity of the protected electrical outlet receptacle. An exemplary implementation is able to turn off the electricity to the electrical outlet receptacle(s). An exemplary implementation comprises shockproof electric outlets.

An electrical outlet receptacle in an example comprises at least one female electrically powered interface such that an electrical connection can be made with the corresponding male connector, a proximity sensor located at least in part sufficiently close to the receptacle interface and configured to indicate the presence of a person or animal in proximity to the receptacle interface, and a controller operable to perform at least one predetermined operation in response to the indicated presence of a person or animal.

The predetermined operation in an example temporarily disables the outlet by interrupting power to the electrical outlet receptacle in response to the indicated presence of a person or animal. The predetermined response in an example comprises illuminating an indicator responsive to the indicated presence of a person or animal. The predetermined response in an example comprises sounding an audible signal for at least some of the duration of indicated proximity of a person or animal. The proximity sensor in an example comprises a capacitive sensor. The sensitivity of the proximity sensor in an example can be manually adjusted and/or altered.

The proximity sensor in an example comprises an electroconductive element of sufficient surface area adjacent and/or sufficiently nearby the electrical outlet receptacle opening and in communication with the controller. The proximity sensor in an example is configured to indicate a change in the state of the electroconductive element corresponding to a change in capacitance caused by a person or animal approaching the electroconductive surface and/or actively moving within the sensing range of the electroconductive surface. The controller in an example is operable to perform a predetermined operation in response to the indicated change in the state of the electroconductive element.

The electroconductive element in an example comprises a thin metal member and/or metalized surface. The thin metal member and/or metalized surface in an example is located beneath the underside of the outlet wall plate. The underside of the outlet wall plate in an example comprises the thin metal member and/or metalized surface. The thin metal member and/or metalized surface in an example is located on the exterior and/or exposed surface of the outlet upon the wall plate or on the receptacle plug itself. The thin metal member and/or metalized surface in an example extends to the exposed surface of the outlet or wall plate. The thin metal member and/or metalized surface surrounds in close proximity and/or minimally to the hot or powered female receptacle openings.

The thin metal member is at least in part covered and/or embedded within a nonconductive element such that the sensing electrode is isolated from earth ground and/or the metallic components of an outlet box. The controller in an example comprises a microcontroller. The controller in an example at least in part comprises a microprocessor. Embedded firmware in an example accommodates permanent changes to the capacitive field in proximity to the electro-conductive element. The embedded firmware in an example performs in place of and/or analogously to a ground fault interrupt (GFI) sequence.

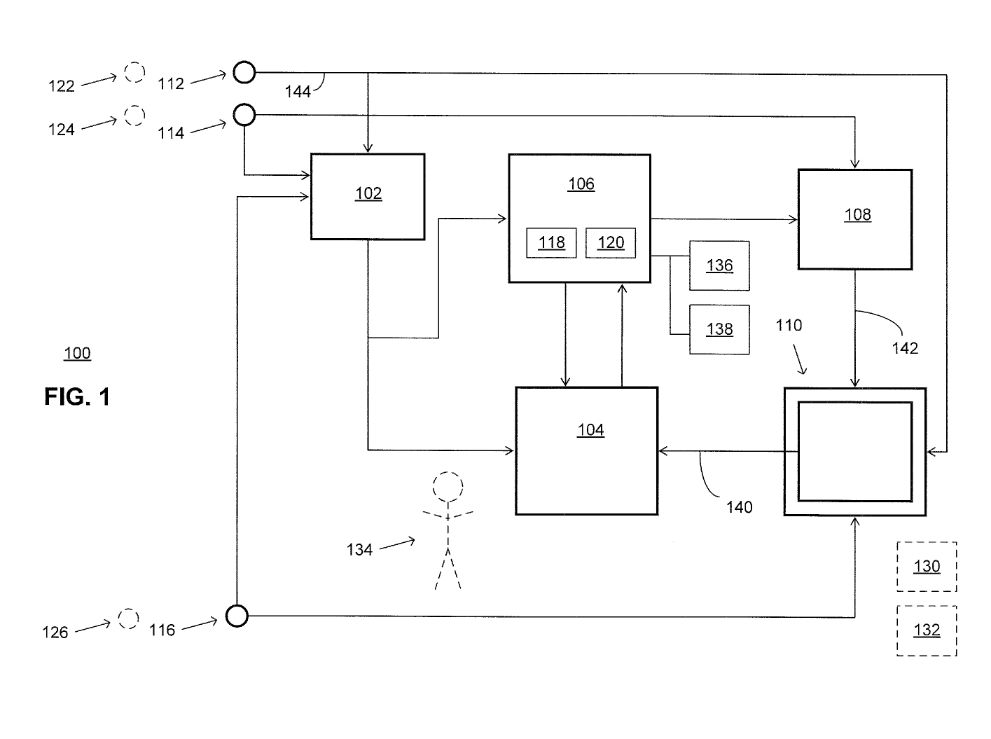

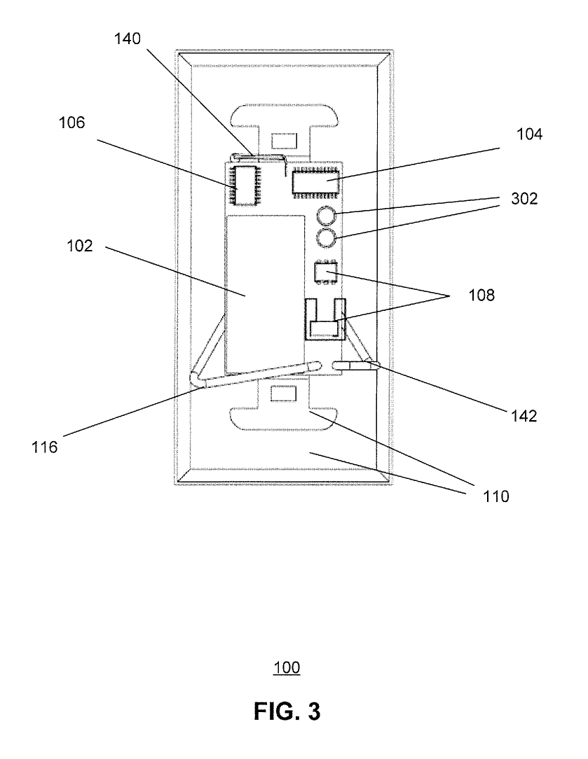

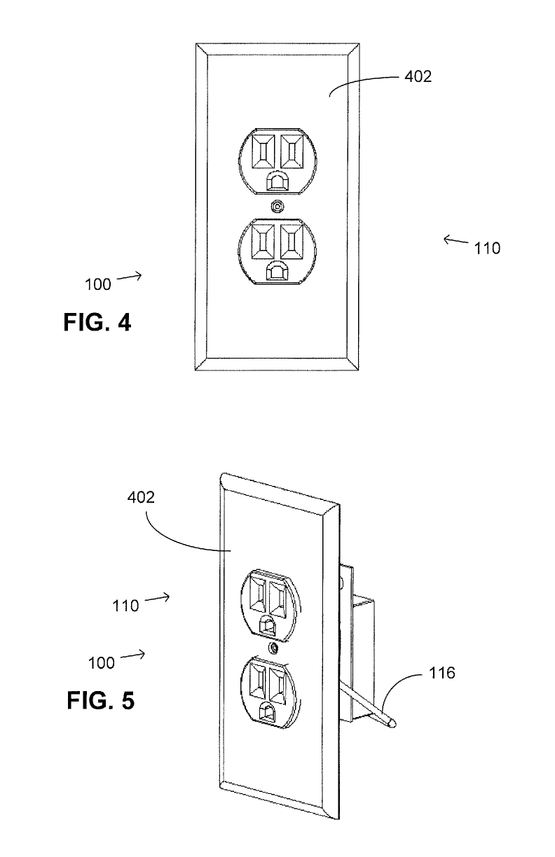

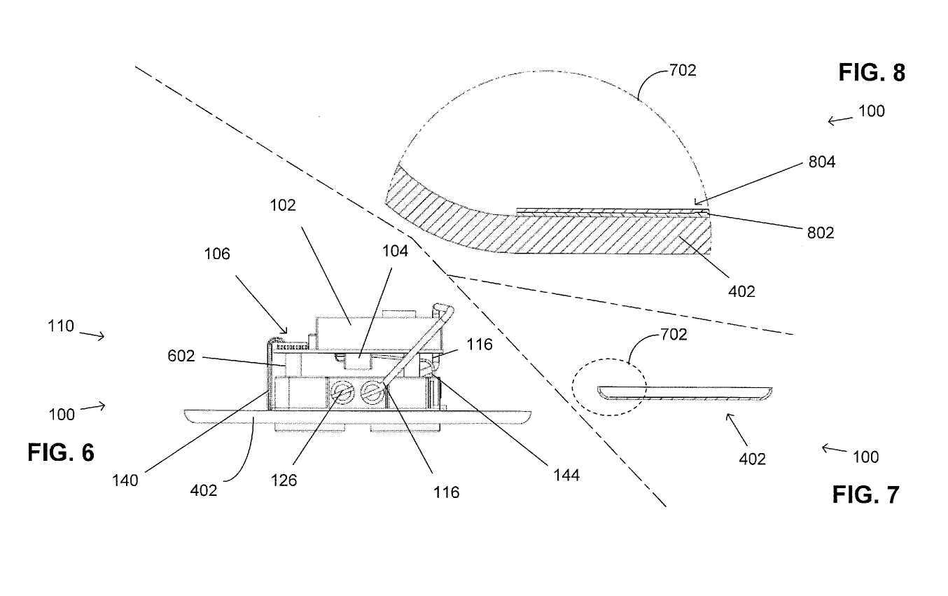

Turning to FIG. 1, an implementation of an apparatus 100 comprises one or more of a power conditioner 102, a proximity sensor 104, a controller 106, a switch 108, an outlet 110, a plurality of connections 112, 114, 116, a light alarm 136, a sound alarm 138, a plurality of connectors 140, 142, 144, an outlet cover and/or wall plate 402 (FIG. 4), and/or a plurality of mounting posts 602 (FIG. 6). The power conditioner 102 comprises electrolytic capacitors 302 (FIG. 3). The power conditioner 102 serves to convert alternating current (AC) power to direct current (DC) power such as through employment of the connections 112, 114, 116. The connection 112 serves as a ground connection to a ground source connection 122, for example, a house and/or building ground source connection. The connection 114 serves as an AC hot connection to an AC hot connection 124, for example, a house and/or building AC hot connection. The connection 116 serves as an AC neutral connection to an AC neutral connection 126, for example, a house and/or building AC neutral connection. The switch 108 comprises as an ON/OFF switch for electrical power to the outlet 110. The outlet 110 comprises an electrically powered outlet receptacle and/or electrode. The controller 106 comprises a processor 118 and memory 120. The connector 140, for example, a wire, serves to couple the proximity sensor 104 and the switch 108. The connector 142, for example, a wire such as a hot wire connection, serves to couple the switch 108 and the outlet 110. The connector 144, for example, a wire such as a ground wire connection, serves to couple the proximity sensor 102 to the connection 112 and the ground source connection 122, and couple the outlet 110 to the connection 112 and the ground source connection 122. The outlet wall plate 402 (FIG. 4) may comprise conductive or non-conductive material, and may be located adjacent to and/or be combined with the outlet 110.

The proximity sensor 104 serves to indicate a presence of a living object 130 within a preselected distance of an electrically powered outlet receptacle as the outlet 110. Exemplary proximity sensors 104 comprise electric field (“e-field”) sensors, arrangements such as arrays of infrared (“IR”) and/or passive infrared (“PIR”) sensors, and radar sensors. Exemplary distances to sense the living object 130 relative to the outlet 110 comprise zero to 30.5 cm (twelve inches), for example, 2.5 cm (one inch) to 5.1 cm (two inches).

The controller 106 performs a preselected control action in connection with an operation of the outlet 110 upon a determination the living object 130 is within the preselected distance of the outlet 110. The proximity sensor 104 and the controller 106 serve to protect somebody, animal or human, as the living object 130 which is so close to the outlet 110 as to be in danger of receiving an electric shock. Such a shock could otherwise injure or even kill such an animal or human as the living object 130.

The proximity sensor 104 comprises an electric field (“e-field”) sensor, arrangement such as an array of infrared (“IR”) and/or passive infrared (“PIR”) sensors, and/or radar sensor that upon a disruption and/or attenuation by the living object 130 returns an adjusted signal to the controller 106. The controller 106 employs the adjusted signal to make the determination the living object 130 is within the preselected distance of the outlet 110 for performance of the preselected control action. The proximity sensor 104 comprises one or a plurality of discrete electroconductive elements that define one or more regions of sensitivity upon, around, and/or proximate to the electrically powered outlet receptacle. Exemplary proximity of the discrete electroconductive elements of the proximity sensor 104 relative to a hot-powered receptacle opening of the outlet 110 comprises zero to 10.2 cm (four inches), for example, zero to 1.9 cm (0.75 inches). One or more discrete electroconductive elements of the proximity sensor 104 comprise a thin metal member and/or metalized surface with sufficient surface area to provide a sensitivity to detect the presence of the living object 130 within the preselected distance. Exemplary thickness of metal of the electroconductive element of the proximity sensor 104 comprises 1.27 μm (0.00005 inches) to 3.81 mm (0.15 inches), for example, 2.54 μm (0.0001 inches) to 1.27 mm (0.05 inches). An exemplary thin metal member and/or metalized surface of the discrete electroconductive element of the proximity sensor 104 comprises an electro-conductive metal, alloy, or coating that comprises sufficient quantities of the material to be effectively conductive. Exemplary metals comprise aluminum, copper, chrome, steel, metalized paint, tin, silver, and gold. The discrete electroconductive element of the proximity sensor 104 comprises surface area sensitivity within zero to 30.5 cm (twelve inches), for example, 2.5 cm (one inch) to 5.1 cm (two inches), for detection of the presence of the living object 130 within the preselected distance.

FIG. 8 is an enlarged view of a region 702 (FIG. 7) about a portion of the wall outlet plate 402. The proximity sensor 104 comprises one or more discrete electroconductive elements 802 (FIG. 8) and a nonconductive element and/or electrically insulating substrate 804 (FIG. 8). The discrete electroconductive elements 802 are located: on an exposed surface of the substrate 804; on an interior surface of the substrate 804, and/or embedded within and/or between a plurality of non-conductive layers of the substrate 804. Exemplary nonconductive material for the substrate 804 comprises an electrical insulator, a biaxially-oriented polyethylene terephthalate (boPET) polyester film, for example, offered under the trade name Mylar, fish paper, nonconductive paint, wood, plastics, and/or decorative laminates.

The one or more discrete electroconductive elements 802 may serve to define a desired relationship such as between operation sensitivity and reliability. A variety of physical geometries may be allowed. Design flexibility in an example accommodates differing physical constraints.

The controller 106 comprises adaptive logic that accommodates a persistent, permanent, and/or predeterminedly allowable change in output from the proximity sensor 104 to the controller 106. The processor 118 executes the adaptive logic from the memory 120. Upon a semi-permanent or permanent presence of a predeterminedly allowable non-living object 132, the adaptive logic of the controller 106 resets an action standard for the preselected control action to a new environment that accommodates the semi-permanent or permanent presence of the predeterminedly allowable non-living object 132. The adaptive logic of the controller 106 serves to adjust for changes in the capacitance of the background and/or environment from the non-living object 132 such as a device with capacitance being placed in proximity of the proximity sensor 104. Such a device as the non-living object 132 may comprise a power supply such as for a mobile phone, iPod®, or cordless telephone. If such a device as the non-living object 132 remains plugged into the outlet 110 for longer than a predetermined time period programmed into the adaptive logic of the controller 106, then the adaptive logic of the controller 106 considers the non-living object 132 as a baseline, rather than as a living person or animal such as the living object 130. An exemplary predetermined time period comprises one to three hundred seconds, for example, four to thirty seconds. The controller 106 compares subsequent capacitance changes against this new baseline.

The proximity sensor 104 comprises sensitivity that is manually-controllable by a user 134 for detection of the presence of the living object 132 within the preselected distance of the outlet 110. The sensitivity of the proximity sensor 104 can be manually adjusted, controlled, and/or varied by the user 134.

The preselected control action by the controller 106 in response to the determination the living object 130 is within the preselected distance of the outlet 110 receptacle serves to: turn off power to the outlet 110 for a preselected amount of time through employment of the switch 108; illuminate an indicator such as the light alarm 136; and/or sound an audible signal such as the sound alarm 138. The preselected control action by the controller 106 serves to promote, create, and/or cause a shock free situation or warn the living object 130 of inherent dangers on or near the outlet 110.

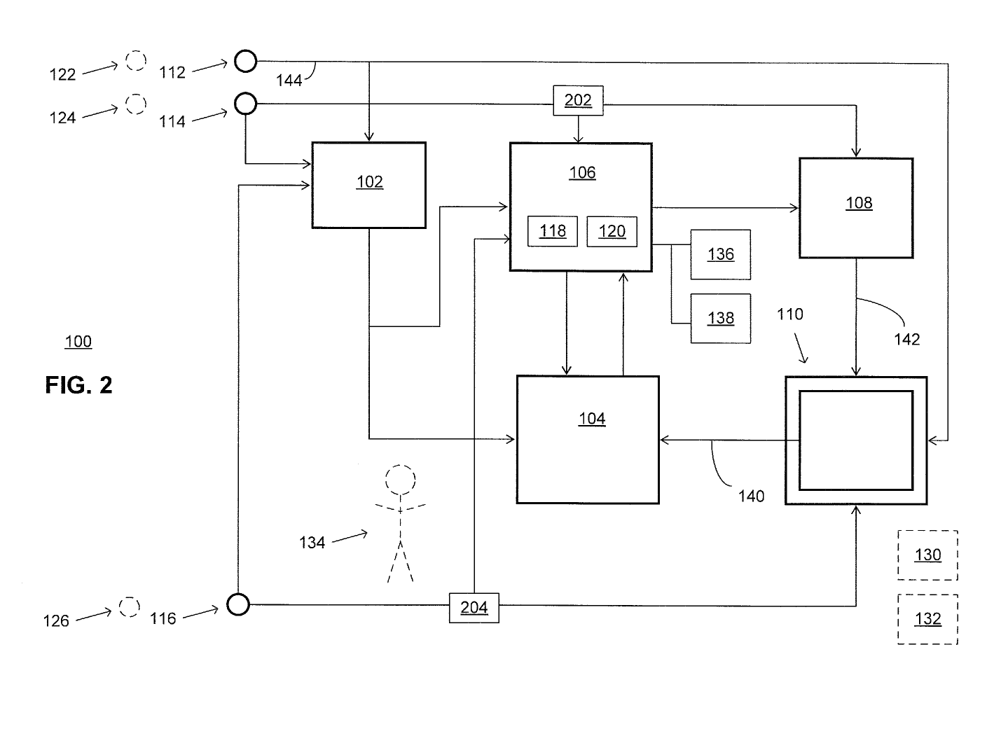

Turning to FIG. 2, an implementation of the apparatus 100 comprises one or more of the power conditioner 102, the proximity sensor 104, the controller 106, the switch 108, the outlet 110, the plurality of connections 112, 114, 116, the light alarm 136, the sound alarm 138, the plurality of connectors 140, 142, 144, the outlet cover and/or wall plate 402 (FIG. 4), the plurality of mounting posts 602 (FIG. 6), and/or sensors 202, 204. The sensors 202, 204 comprise electric current sensors. The sensors 202, 204 serve to allow Ground Fault Interrupter (“GFI”) and Ground Fault Circuit Interrupter (“GFCI”). GFI serves to compare electrical current flowing in an electrically neutral line and/or wire coupled with the connection 116, to electrical current flowing in an electrically hot line and/or wire coupled with the connection 114. In an event of electrical current imbalance an assumption is a current path exists to Earth ground such as through a person or object, so the controller 106 interrupts the power. The sensor 202 is coupled in series with an AC hot connection as the connection 114. The sensor 204 is coupled in series with an AC neutral connection as the connection 116. The controller 106 employs the sensors 202, 204 to check for imbalance in the electrical current and cut the power upon a determination by the controller 106 that an imbalance in the electrical current exists.

The controller 106 employs the sensors 202, 204 to serve as a Ground Fault Circuit Interrupter (GFI) through a determination whether or not an imbalance exists in comparative current drawn between a hot connection as the connection 114 and a neutral connection as the connection 116. Upon a determination the imbalance exists in the comparative current drawn between the hot connection as the connection 114 and the neutral connection as the connection 116 the controller 106 depowers the outlet 110, for example, until manual intervention or resetting. GFI serves to shock the living object 130 but prevent the living object 130 from being electrocuted. The outlet 110 comprises an electric powered outlet receptacle mounted in a wall, an outlet replicator, an outlet strip, a surge suppressor, a Ground Fault Circuit Interrupter (“GFCI”), and/or an extension cord.

The controller 106 serves to protect the living object 130 from accidental electrical shock and/or electrical connection through temporary cutting of power to the outlet 110 upon a determination the living object 110 is within a preselected distance of the outlet 110, through employment of the proximity sensor 104. The controller 106 makes a determination of significance of a change in amplitude of an electric field adjacent to the outlet 110 through employment of the proximity sensor 104. The controller 106 turns off power to the outlet 110 for a preselected amount of time. An exemplary preselected amount of time comprises one to three hundred seconds, for example, four to thirty seconds. In an example, the controller 106 turns off power to the outlet 110 for a discrete amount of time, for example, one to three hundred seconds or four to thirty seconds, and an open ended time, leaving the power off until manually reset upon a determination the change in amplitude of the electric field adjacent to the outlet 110 meets a preselected threshold, for example, of a change greater than 0.5% or greater than 2% through employment of the switch 108. The controller 106 employs the proximity sensor 104 to sense a meaningful change in amplitude of the electric field and turns off power to the outlet 110 for the preselected amount of time before returning power to the outlet 110.

The controller 106 employs the proximity sensor 104 to intermittently measure amplitude of the electric field for comparison with a preselected baseline amplitude. The baseline amplitude comprises a stored value, for example, in the memory 120, that serves as a reference. The preselected threshold comprises a percent deviation from that stored value. Upon a determination amplitude of the electric field is sufficiently different, for example, greater than 0.5% change or greater than 2% change, from the preselected baseline, the controller 106 keeps off power to the outlet 110 for another interval of the preselected amount of time, through employment of the switch 108. The controller 106 employs the proximity sensor 104 to intermittently measure the amplitude of an electric field signal and compare the amplitude to a predetermined baseline amplitude such as a set point. If the measured signal is substantially different than the baseline, the controller 106 employs the switch 108 to keep off the power to the outlet and the controller 106 restarts an internal timer of the controller 106. The controller 106 may implement the internal timer through employment of software in the memory 120 executed by the processor 118.

The controller 106 adapts the preselected threshold to a persistent, continuous, permanent, and/or predeterminedly allowable change in the electrical field. The controller 106 compares subsequent measurements to both the baseline and the predetermined number of previously measured values. As long as the measured signal continues to be significantly different than both the baseline and each of the predetermined number of measured values, the controller 106 causes the electric power to the outlet 110 to remain off such as through employment of the switch 108. If at some point the difference in subsequently measured values or between current measured values and previously measured values is greater than or less than a predetermined amount, the controller 106 resets the baseline to a new value and restores the power to the outlet 110 in a predetermined amount of time. A predetermined allowable change might be the use of a wall transformer in the outlet 110. The controller 106 determines the change as permanent and allowable by storing an array of consecutive most recent measures, for example, storing two to one hundred consecutive numbers and comparing them amongst themselves. If the numbers are not different from each other, for example, less than 0.5% of the total average or full scale, then the controller 106 resets the preselected baseline amplitude to the average of the stored values. When a transformer is plugged into the outlet 110, the first reaction by the controller 106 is to turn the power off while continuing to read sensor values from the proximity sensor 104. Once the previous set of measures stops fluctuating, for example, all within 0.5% of each other, the controller 106 restores the power to the outlet 110 through employment of the switch 108 and sets a new baseline.

The controller 106 comprises an exemplary implementation of an algorithm, procedure, program, process, mechanism, engine, model, coordinator, module, application, software, code, and/or logic.

An illustrative description of an exemplary operation of an implementation of the apparatus 100 is presented, for explanatory purposes. Exemplary logic of the controller 106 serves to continuously compare the measured value to a baseline and turns the power off for a time when there is a deviation. Exemplary logic of the controller 106 serves to reset the baseline when the change in value is determined to be permanent and/or steady. The logic may run continuously.

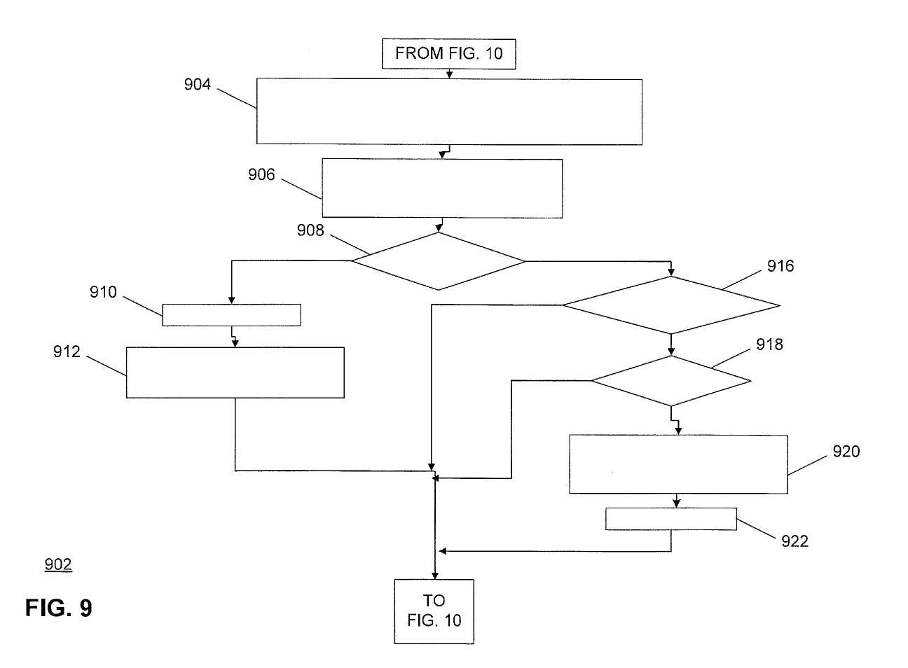

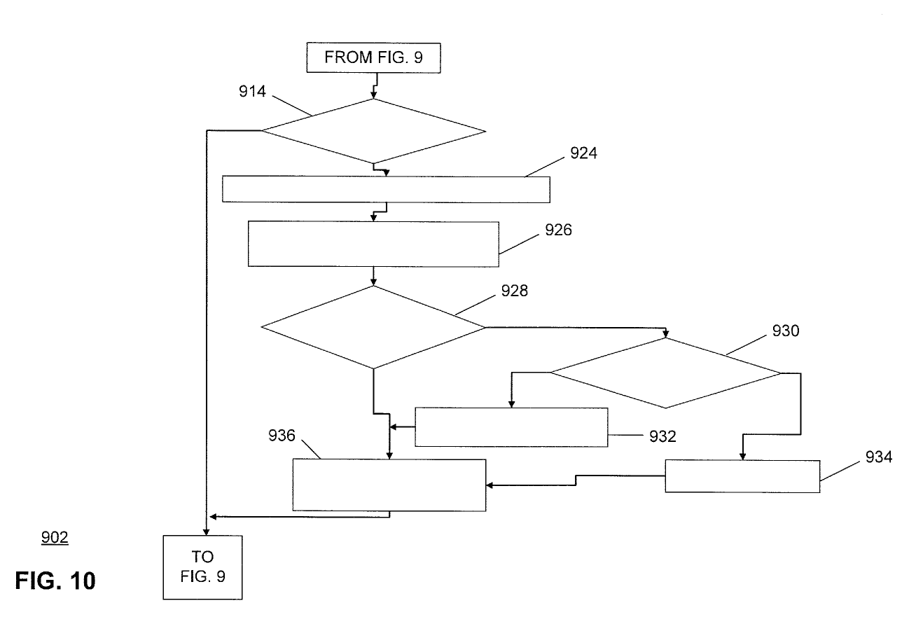

Turning to FIG. 9, in an exemplary logic flow 902 at STEP 904 the controller 106 reads the proximity sensor 104 a plurality of times, rejects extraneous values, and computes an average capacitance level or voltage level proportional to the capacitance near the electrode of the outlet 110. At STEP 906 the controller 106 compares the capacitance level from the proximity sensor 104 with the current background and/or environmental capacitance level. At STEP 908 the controller 106 makes a determination whether or not the difference in capacitance is too large. If yes at STEP 908, the controller 106 proceeds to STEP 910 and sets AC power off. The controller 106 proceeds from STEP 910 to STEP 912. At STEP 912 the controller 106 sets motion time interval and prevents AC power turn on. STEP 912 proceeds to STEP 914 (FIG. 10).

If no at STEP 908, the controller 106 proceeds to STEP 916 and makes a determination whether or not the motion time interval has expired. If no at STEP 916, the controller 106 proceeds to STEP 914 (FIG. 10). If yes at STEP 916, the controller 106 proceeds to STEP 918 and makes a determination whether or not the AC power is off. If no at STEP 918, the controller 106 proceeds to STEP 914 (FIG. 10). If yes at STEP 918, the controller 106 proceeds to STEP 920. At STEP 920 the controller 106 resets time interval for background capacitance level adjustment and resets count of values. The controller 106 proceeds from STEP 920 to STEP 922. At STEP 922 the controller 106 sets motion time interval and prevents AC power turn on. STEP 922 proceeds to STEP 914 (FIG. 10).

Turning to FIG. 10, at STEP 914 the controller 106 makes a determination whether or not the background adjustment time has expired. If no at STEP 914, the controller 106 returns to STEP 904 (FIG. 9). If yes at STEP 914, the controller 106 proceeds to STEP 924. At STEP 924 the controller 106 saves read level in storage location specified by counter. The controller 106 proceeds from STEP 924 to STEP 926. At STEP 926 the controller 106 compares multiple saved levels taken over extended period of time. The controller 106 proceeds from STEP 926 to STEP 928 and makes a determination whether or not the preselected number of new values been stored. If yes at STEP 928, the controller 106 proceeds to STEP 930 and makes a determination whether or not all values are within allowed difference tolerance. If yes at STEP 930, the controller 106 proceeds to STEP 932 and sets background level to average of stored values. The controller 106 proceeds from STEP 932 to STEP 936 and resets time interval for background level adjustment. If no at STEP 930, the controller 106 proceeds to STEP 934 and resets count of values. The controller 106 proceeds from STEP 934 to STEP 936 and resets time interval for background level adjustment. If no at STEP 928, the controller 106 proceeds to STEP 936 and resets time interval for background level adjustment. STEP 936 returns to STEP 904 (FIG. 9).

An implementation of the apparatus 100 comprises a plurality of components such as one or more of electronic components, chemical components, organic components, mechanical components, hardware components, optical components, and/or computer software components. A number of such components can be combined or divided in an implementation of the apparatus 100. In one or more exemplary implementations, one or more features described herein in connection with one or more components and/or one or more parts thereof are applicable and/or extendible analogously to one or more other instances of the particular component and/or other components in the apparatus 100. In one or more exemplary implementations, one or more features described herein in connection with one or more components and/or one or more parts thereof may be omitted from or modified in one or more other instances of the particular component and/or other components in the apparatus 100. An exemplary technical effect is one or more exemplary and/or desirable functions, approaches, and/or procedures. An exemplary component of an implementation of the apparatus 100 employs and/or comprises a set and/or series of computer instructions written in or implemented with any of a number of programming languages, as will be appreciated by those skilled in the art. An implementation of the apparatus 100 comprises any (e.g., horizontal, oblique, angled, or vertical) orientation, with the description and figures herein illustrating an exemplary orientation of an exemplary implementation of the apparatus 100, for explanatory purposes.

An implementation of the apparatus 100 encompasses an article and/or an article of manufacture. The article comprises one or more computer-readable signal-bearing media. The article comprises means in the one or more media for one or more exemplary and/or desirable functions, approaches, and/or procedures.

An implementation of the apparatus 100 employs one or more computer readable signal bearing media. A computer-readable signal-bearing medium stores software, firmware and/or assembly language for performing one or more portions of one or more implementations. An example of a computer-readable signal bearing medium for an implementation of the apparatus 100 comprises a memory and/or recordable data storage medium of the memory 120. A computer-readable signal-bearing medium for an implementation of the apparatus 100 in an example comprises one or more of a magnetic, electrical, optical, biological, chemical, and/or atomic data storage medium. For example, an implementation of the computer-readable signal-bearing medium comprises one or more floppy disks, magnetic tapes, CDs, DVDs, hard disk drives, and/or electronic memory. In another example, an implementation of the computer-readable signal-bearing medium comprises a modulated carrier signal transmitted over a network comprising or coupled with an implementation of the apparatus 100, for instance, one or more of a telephone network, a local area network (“LAN”), a wide area network (“WAN”), the Internet, and/or a wireless network. A computer-readable signal-bearing medium in an example comprises a physical computer medium and/or computer-readable signal-bearing tangible medium.

The steps or operations described herein are examples. There may be variations to these steps or operations without departing from the spirit of the invention. For example, the steps may be performed in a differing order, or steps may be added, deleted, or modified.

Although exemplary implementation of the invention has been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
a proximity sensor that serves to indicate a presence of a living object within a preselected distance of an electrically powered outlet receptacle; and
a controller that performs a preselected control action in connection with an operation of the electrically powered outlet receptacle upon a determination the living object is within the preselected distance of the electrically powered outlet receptacle.

2. The apparatus of claim 1, wherein the proximity sensor comprises an electric field sensor that upon a disruption and/or attenuation by the living object returns an adjusted signal to the controller;
wherein the controller employs the adjusted signal to make the determination the living object is within the preselected distance of the electrically powered outlet receptacle for performance of the preselected control action.

3. The apparatus of claim 1, wherein the proximity sensor comprises one or more discrete electroconductive elements that define one or more regions of sensitivity upon, around, and/or proximate to the electrically powered outlet receptacle.

4. The apparatus of claim 3, wherein one or more of the one or more discrete electroconductive elements comprise surface area sensitivity for detection of the presence of the living object within the preselected distance.

5. The apparatus of claim 3, wherein the proximity sensor comprises the one or more discrete electroconductive elements and an electrically insulating substrate, wherein the one or more discrete electroconductive elements are located:
on an exposed surface of the electrically insulating substrate;
on an interior surface of the electrically insulating substrate, and/or
embedded within and/or between a plurality of non-conductive layers of the electrically insulating substrate.

6. The apparatus of claim 1, wherein the controller comprises adaptive logic that accommodates a persistent, permanent, and/or predeterminedly allowable change in output from the proximity sensor to the controller;
wherein upon a semi-permanent or permanent presence of a predeterminedly allowable non-living object, the adaptive logic resets an action standard for the preselected control action to a new environment that accommodates the semi-permanent or permanent presence of the predeterminedly allowable non-living object.

7. The apparatus of claim 1, wherein the proximity sensor comprises sensitivity to the presence of the living object within the preselected distance of the electrically powered outlet receptacle that is manually-controllable by a user.

8. The apparatus of claim 1, wherein the preselected control action by the controller in response to the determination the living object is within the preselected distance of the electrically powered outlet receptacle serves to:
turn off power to the electrically powered outlet receptacle for a preselected amount of time;
illuminate an indicator; and/or
sound an audible signal.

9. The apparatus of claim 1, further comprising:
a plurality of electric current sensors;
wherein the controller employs the plurality of electric current sensors to serve as a Ground Fault Circuit Interrupter (GFI) through a determination whether or not an imbalance exists in comparative current drawn between hot and neutral electrical connections;
wherein upon a determination the imbalance exists in the comparative current drawn between the hot and neutral electrical connections the controller depowers the electrically powered outlet receptacle.

10. A method, comprising the step of:
protecting a living object from accidental electrical shock and/or electrical connection through temporary cutting of power to an electrically powered outlet receptacle upon a determination the living object is within a preselected distance of the electrically powered outlet receptacle through employment of a proximity sensor.

11. The method of claim 10, wherein the step of protecting the living object comprises the steps of:
making a determination of significance of a change in amplitude of an electric field adjacent to the electrically powered outlet receptacle through employment of the proximity sensor;
turning off power to the electrically powered outlet receptacle for a preselected amount of time upon a determination the change in amplitude of the electric field adjacent to the electrically powered outlet receptacle meets a preselected threshold; and
preparing to return power to the electrically powered outlet receptacle upon expiration of the preselected amount of time.

12. The method of claim 11, wherein the steps of making the determination of significance of the change in amplitude of the electric field, turning off power to the electrically powered outlet receptacle for the preselected amount of time, and preparing to return power to the electrically powered outlet receptacle comprise the steps of:
intermittently measuring amplitude of the electric field for comparison with a preselected baseline amplitude; and
upon a determination amplitude of the electric field is sufficiently different from the preselected baseline, keeping off power to the electrically powered outlet receptacle for another interval of the preselected amount of time.

13. The method of claim 11, wherein the steps of making the determination of significance of the change in amplitude of the electric field and turning off power to the electrically powered outlet receptacle for the preselected amount of time comprise the step of:
adapting the preselected baseline amplitude to a persistent, continuous, permanent, and/or predeterminedly allowable change in the electrical field if the significance of the change in amplitude of the electric field is constant, consistent, or unchanged for a preselected number of consecutive measurements or readings or for a preselected amount of time followed by returning the power to the electrically powered outlet receptacle.
